(19) United States
(12) Patent Application Publication
(10) Pub. No.: US 2008/0149669 A1
(43) Pub. Date: Jun. 26, 2008

(54) Beverage dispenser

(76) Inventors: Scott Nicholson, River Falls, WI (US); Leonard Switzer, East Bethel, MN (US); Stephen J. Czeck, Shoreview, MN (US); John Hunter, Rogers, MN (US)

Correspondence Address: PYLE & PIONTEK LLC, 221 N. LASALLE STREET, SUITE 2036, CHICAGO, IL, 60601, US

(21) Appl. No.: 11/642,229

(22) Filed: Dec. 20, 2006

(51) Int. Cl. B67D 5/56; B65D 37/00

(52) U.S. Cl. 222/129.1; 222/207; 222/214

(57) ABSTRACT

A beverage dispenser for dispensing a post-mix beverage is characterized by a disposable concentrate beverage unit and a disposable pump unit that are housed in a refrigerated area of the beverage dispenser. The pump unit is operable to dispense metered volumes of concentrate for mixing with a regulated flow of diluent to dispense a required ratiometric mixture thereof.

### FIELD OF THE INVENTION

This invention relates to beverage dispensers and more especially relates to beverage dispensers having disposable diaphragm type pumps.

### BACKGROUND OF THE INVENTION

Beverage dispensers commonly provide a ratiometric mixture of a beverage concentrate and a diluent and this is commonly done by regulating the flow of two pressurised sources of concentrate and diluent. However, some concentrates are highly viscous and do not flow easily, a problem which is enhanced at the low temperatures at which they are stored. The variance in viscosity means that it is hard to accurately meter a pressurised flow of viscous concentrates, for example orange juice concentrate, and to do so effectively requires a pressure much higher than is conventionally used. This problem is overcome to some degree by current juice dispensers which utilise a positive displacement pump to pump the concentrate and regulate the flow of diluent accordingly.

Another problem associated with the viscosity of some concentrates is that they do not readily mix with a diluent, for example water. This has two adverse effects. The first is that when the beverage is dispensed into a receptacle for consumption, there is often found a slug of unmixed concentrate at the bottom of the receptacle, which is unappealing to the consumer. Secondly, due to the viscosity and high sugar content of juice concentrates, the concentrate will tend to adhere to the internal components of the dispenser and is not easily cleaned by simple rinsing. This is particularly relevant for example, with orange juice concentrate, which can become highly toxic through bacterial growth if allowed to sit for long period of time at room temperature. A common contributory factor to these two problems is the non disposable part of the machine through which the concentrate (diluted or undiluted) passes.

There are three systems known in the art which provide a more sanitary system for dispensing concentrate by use of partially disposable components. Two of these are use of a rotary peristaltic pump, the deformable tube of which forms an integral part of the disposable concentrate reservoir, and a positive displacement pump comprising a disposable portion supplied with the reservoir and a non-disposable drive to reciprocate the pump, drawing fluid into, and expelling it from, the disposable portion, as shown in U.S. Pat. Nos. 5,114,047 and 5,154,319.

There are several problems associated with these designs, including problems with pumping high viscosity concentrates, long term permanent deformation of peristaltic tubes, inadequate mixing of concentrate and diluent and “streaming”, which is the visual effect of seeing stratification of concentrate and diluent as the beverage is dispensed.

A third solution has been proposed in EP 1 716 068, which comprises a disposable membrane pump driven by application of pressure and vacuum to the diaphragm to pump the concentrate. This solution overcomes many of the problems associated with previous designs, but has limitations. In particular, if the dispense is stopped part way through a dispense cycle, i.e., when a pump chamber is partially dispensed, it is not possible to easily determine how much concentrate has been dispensed from that pump chamber. The result of this is that it is virtually impossible to reliably get an exact ratiometric mix of concentrate to diluent when the dispense is stopped with a partially empty pump chamber. This problem is amplified when only dispensing a small amount, for example in a mixed drink (e.g., vodka and orange juice). In addition, the use of pressure and vacuum pumps and all the associated valving creates an overly complex solution needing a detailed control system that has many potential failure modes.

### OBJECT OF THE INVENTION

A primary object of the present invention is to provide an improved sanitary beverage dispenser having a diaphragm pump and which mitigates some of the problems with known systems.

### SUMMARY OF THE INVENTION

According to the present invention, there is provided a beverage dispenser for dispensing a post-mix beverage from a disposable concentrate pump unit comprising two inlet valves, two pump chambers having a flexible membrane and two outlet valves, the dispenser comprising a diluent supply system to supply a flow of diluent to a section of the disposable pump unit; a cabinet area for receiving at least one reservoir of concentrate; and at least one pumping station for receiving, retaining and actuating a disposable pump unit. The pumping station comprises a drive plunger associated with each pump chamber and arranged for reciprocal movement to displace the flexible membrane in a first direction to expel concentrate from the pump chambers and in a second direction to draw concentrate into the pump chambers; and vacuum means for applying a pressure differential across the flexible membrane when a drive plunger is moving in its second direction, so as to cause concentrate to be drawn into the pump cavity as the plunger is withdrawn.

In a contemplated embodiment of the invention, the negative pressure differential across the flexible membrane when a drive plunger is moving in its second direction maintains the membrane in contact with the drive plunger as concentrate is drawn into the pump chambers. Each drive plunger is driven by a cam, and the cams are profiled such that movement of a drive plunger in the second direction is faster than movement of the plunger in the first direction, resulting in concentrate being drawn into a pump chamber in a shorter time interval than it is expelled from the pump chamber.

Each pump chamber has a dedicated vacuum means and a conduit leading from the vacuum means to the outer side of the flexible membrane, and the disposable concentrate pump sealingly engages with the pumping station to form an enclosed area between each pump chamber and the pumping station. Preferably, each vacuum means comprises an enclosed chamber having a vacuum pump inlet valve and a vacuum pump outlet valve, the vacuum pump inlet valve being in the conduit between the vacuum means and the outer side of the flexible membrane; and a vacuum drive member movable in the enclosed chamber in a first direction to draw air through the vacuum pump inlet valve and in the other direction to expel air from the enclosed chamber, thereby creating a pressure differential across the flexible membrane. The vacuum pump inlet and outlet valves may be check valves.

Each conduit passes into and through the drive plunger, terminating at an opening in the end of said plunger which, in use, displaces the flexible membrane. Each vacuum drive member is driven by a cam, and the vacuum drive member cam and drive plunger cam for each pump chamber are driven by a common drive shaft. The drive shafts for each pump chamber are driven simultaneously by a single motor.

Each of the concentrate pump inlet valves comprises a flexible membrane overlaying an inlet orifice, and the pumping station further comprises an inlet valve plunger associated with each inlet orifice and arranged for reciprocal movement to displace the flexible membrane in a first direction to cover and close the inlet orifice, thereby preventing flow of concentrate therethrough, and in a second direction to allow the membrane to move away from the orifice and allow concentrate to pass therethrough. Each inlet valve plunger is driven by the common drive shaft by means of a cam.

In a contemplated arrangement, each of the concentrate pump outlet valves comprises a flexible membrane overlaying an outlet orifice, and the pumping station further comprises an outlet valve plunger associated with each outlet orifice and arranged for reciprocal movement to displace the flexible membrane in a first direction to cover and close the outlet orifice, thereby preventing flow of concentrate therethrough, and in a second direction to allow the membrane to move away from the orifice and allow concentrate to pass therethrough. Each outlet valve plunger is driven by the common drive shaft by means of a cam. Alternatively, each outlet valve is a check valve.

Where present, each valve cam is profiled to open the valve quickly and to maintain it in its open position as the pump chamber fills with, or expels, concentrate, and to then close the valve quickly. The pumping station actuates the two sets of inlet valves, pump chamber and outlet valves out of phase with each other. Advantageously, the flow of concentrate expelled from each of the pump chambers overlaps one another so that, in use, concentrate is constantly expelled from the concentrate pump.

The diluent supply system may comprise a flow meter to measure the flow of diluent passing therethrough, and the rate of pumping concentrate may be controlled to be dependant on the flow of water being supplied to the pump, which may be accomplished by controlling the speed of a motor for a concentrate pump to be dependant on the measured flow of water. Desirably, the flow of water is set to a desired flow rate.

The foregoing and other objects, advantages and features of the invention will become apparent from the following detailed description, when taken in conjunction with the accompanying drawings.

### BRIEF DESCRIPTION OF THE DRAWINGS

FIG. 1 is a schematic diagram of a beverage dispenser in accordance with the teachings of the present invention;

FIG. 2 shows a disposable pump cartridge suitable for use with the dispenser;

FIG. 3 shows an alternative pump cartridge suitable for use with the dispenser;

FIG. 3a is a cross section of a valve for use in the pump cartridge of FIG. 3.

FIG. 4 is a diagram of a dispenser in accordance with the invention;

FIG. 5 is a diagram of a dispenser in accordance with the invention with the front cover open and the retainer plates open;

FIG. 6 is a diagram of a disposable reservoir and pump unit for use with the invention;

FIG. 7 shows a perspective view of a pumping station in accordance with the invention with a pump cartridge presented to it;

FIG. 8 shows a perspective view of a pumping station in accordance with the invention;

FIG. 9 shows a top view of a pumping station in accordance with the invention;

FIG. 10 shows a section view on “A-A” of FIG. 9;

FIG. 11 shows a valve plunger and associated cam; and

FIG. 12 shows a cam profile suitable for driving a drive plunger;

### DETAILED DESCRIPTION

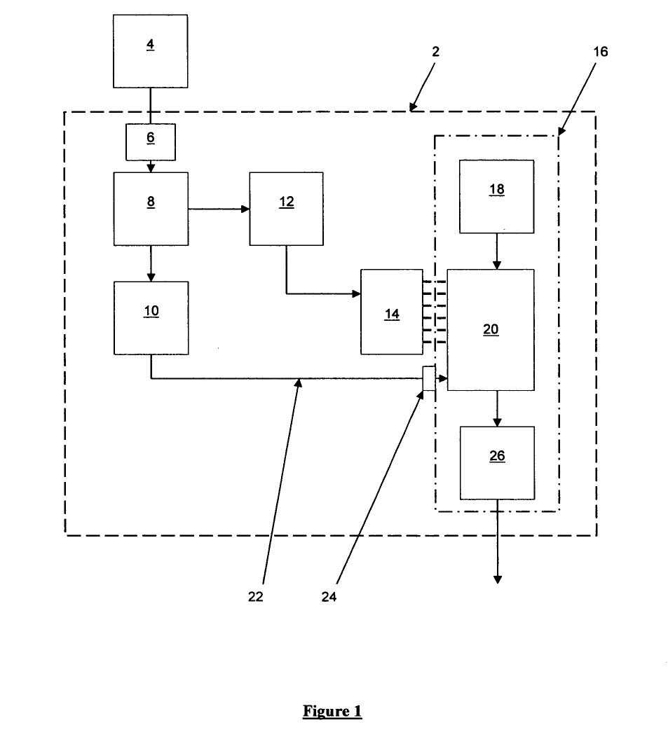

Referring to FIG. 1, a schematic diagram of a beverage dispenser is shown in which a beverage dispenser 2 is connected to a diluent supply 4, which may be a continuous supply, for example a supply of mains water. An adjustable valve 6 controls the flow of the diluent through the dispenser. Normally, the flow through the valve 6 will be set below the maximum flow the supply 4 is capable of supplying to ensure there is always sufficient flow. The flow of the diluent is measured using a flow turbine flow sensor 8. After passing through the flow sensor 8, the diluent is cooled in a cooling unit 10 using a water bath heat exchanger which comprises an outer coil through which a refrigerant passes, cooling the water and forming a bank of ice surrounding the refrigerant coil, the ice bank maintaining a constant temperature within the water and a reserve of cooling energy to maintain that temperature. In the liquid phase of the water bath is a secondary coil through which the water or diluent passes, cooling as it does so to a temperature commonly in the region 1 to 6 degrees centigrade. Control electronics 12 receive signals from a flow sensor and control the speed of a motor 14 to adjust the dispense rate of concentrate from a disposable concentrate unit 16 situated within or attached to the dispenser 2 and comprising a concentrate reservoir 18, a dual-cavity pump unit 20 connected to the concentrate reservoir 18, a connection 22 for diluent conduit 24, and a static mixer 26 to mix the concentrate and diluent to form a homogeneous mixture.

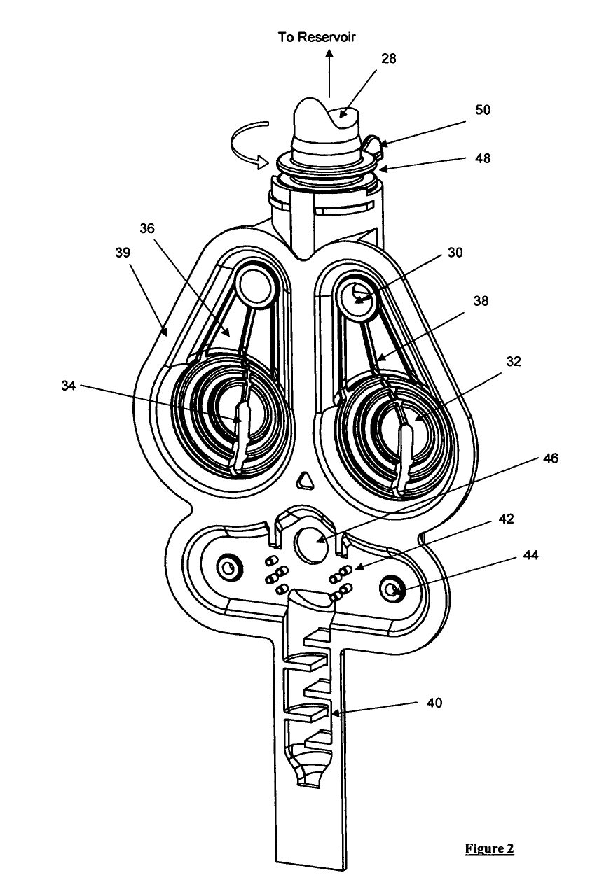

Referring to FIG. 2, a rigid plastic pump cartridge is shown and comprises a fluid inlet 28 leading to two chamber inlet ports 30 from which there is a flow path to the concave cavity 32 and its associated chamber outlet 34. Provided in surface of the concave cavity 30 and a flat area 36 are recessed grooves 38 which, should the flexible film (not shown) that covers the pump cartridge and is welded to a surface 39 trap an occluded area of the pumped fluid remote from the chamber outlet 34, will always provide a channel for the fluid to be forced out of to ensure that the chamber is fully emptied every time, thus giving a repeatable volumetric output from the pump cartridge. The pump cartridge has had all excessive plastic removed and designed for production by injection moulding techniques from polyethylene. The pump cartridge further comprises an integrated static mixer 40, which is formed as a feature of the plastic moulding enclosed by flexible film which is heat welded thereover. Additionally, an array of obstructions 42 are provided between a pair of outlet ports 44 and the static mixer 40, such that fluid is sheared immediately prior to it admixing with the diluent entering via diluent inlet 46. Once admixed with the diluent, the fluid passes through the static mixer 40 and is dispensed therefrom as a homogeneous fluid. In the fluid inlet 28 is a closure 48 that is rotatable by means of a lever 50 to open or close the flow from the reservoir (not shown) to the inlet ports 30. In use, movement of the flexible film draws concentrate into the concave cavities 32, which in combination with the flexible film form pump cavities, and expels it therefrom via the outlet orifices 44 where it mixes with diluent entering via diluent inlet 46 before passing therewith through the static mixer 40 before exiting the pump cartridge as a diluted beverage. In use, the flexible film is moved on and off the inlet orifices 30 and the outlet orifices 44 by a mechanical means (described below) so as to allow, or obstruct, flow therethrough. The flexible film over the pump cavities 32 is displaced away from the cavities 32 by a vacuum means (described below) to draw concentrate through inlet orifices 30 into the pump cavities and is displaced by mechanical means (described below) to expel concentrate from the pump cavities 32 via outlet orifices 44.

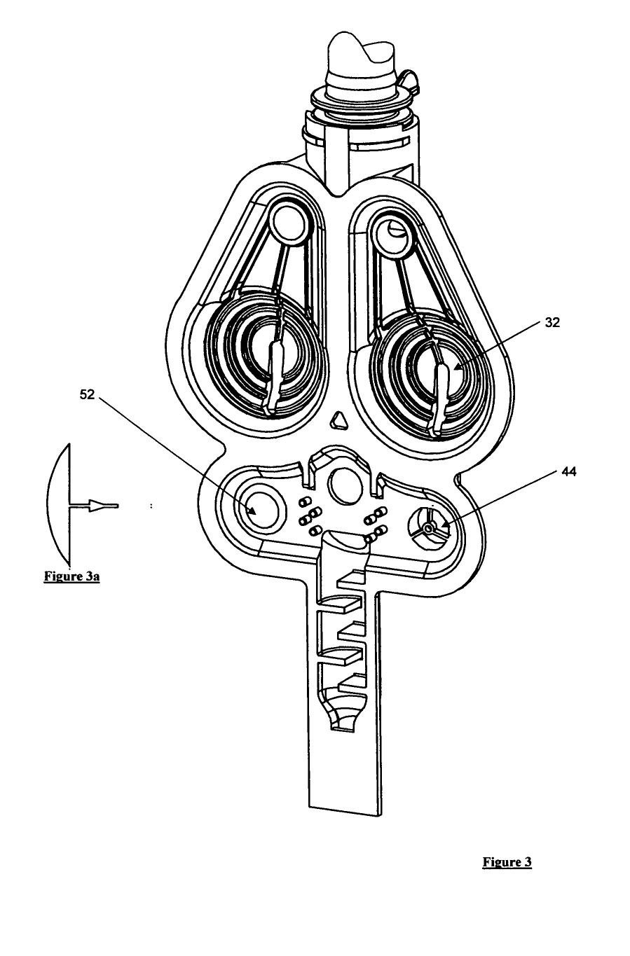

Referring now to FIG. 3, the same pump cartridge is shown as in FIG. 2, except that it is additionally provided with check valves 52 in the outlet orifices 44, which allow flow in the direction from the pump chamber towards the static mixer, but prevent flow in the opposite direction. The check valves 52 are “umbrella” valves made of an elastomeric polymer, but any known alternatives may be used. By using these check valves 52, the need for mechanical closing of the outlet orifices 44 is removed.

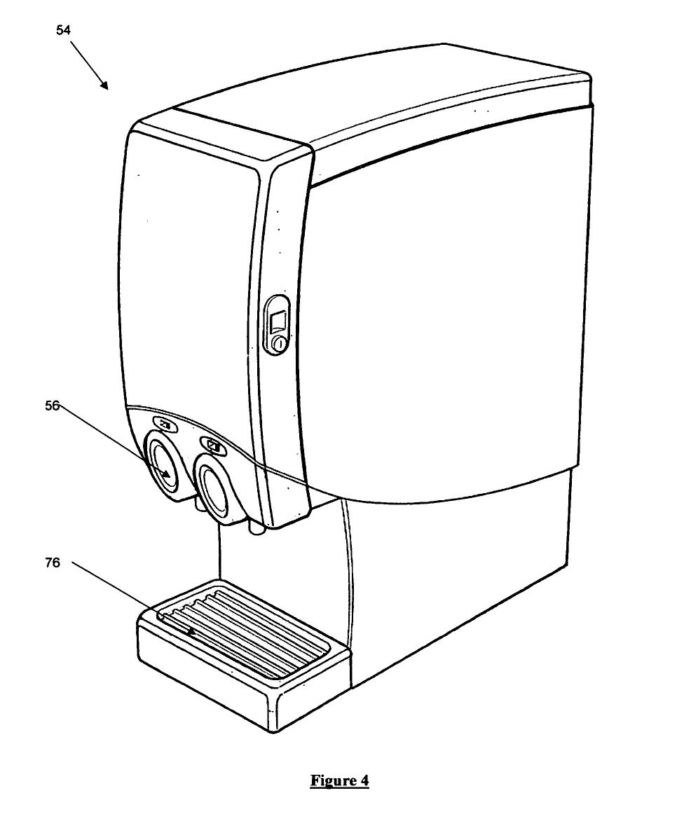

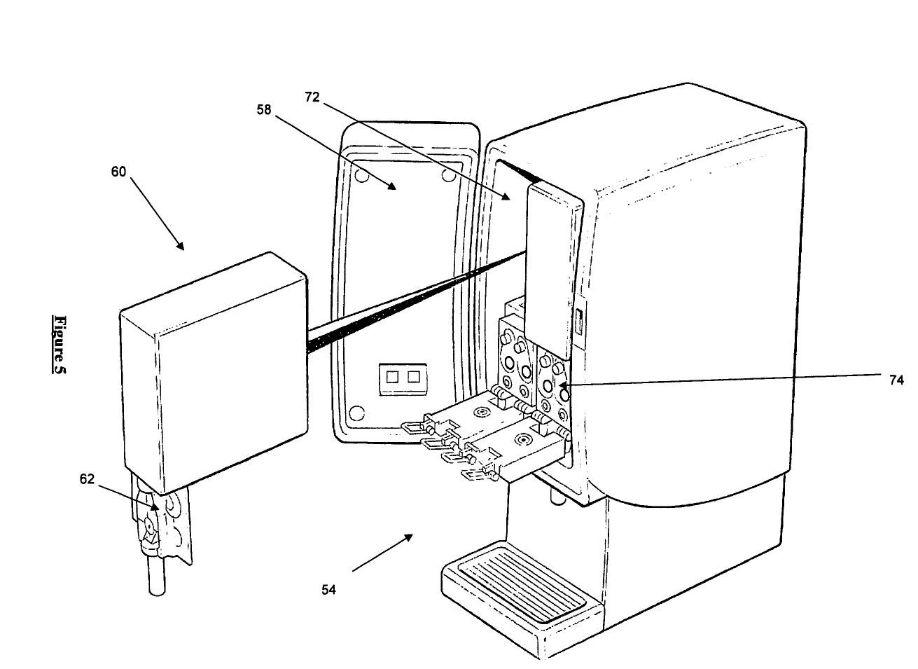

Referring to FIGS. 4 to 6, a dispenser 54 is shown with a user interface 56 to allow the user to select to dispense a beverage. A door 58 of the dispenser opens to allow the user to load and unload a disposable concentrate unit 60. The disposable concentrate unit 60 consists of a flexible reservoir (not shown) connected to a dual cavity pump unit 62 which has a diluent inlet 64 and a static mixer 68. The flexible reservoir is placed within a re-usable rigid container 70 that supports the flexible reservoir. Diluent enters the pump unit 62 downstream of the cavities which pump the concentrate and the pumped concentrate and diluent then flow together to the static mixer 68, which uses turbulence and fluid shear as the admixture passes therethrough to produce a homogeneous mixture.

The disposable concentrate unit 60 and disposable pump unit 62 are placed in the dispenser 54, such that both are within the refrigerated area 72 of the dispenser 54, and the pump unit 62 is positioned such that it interfaces with the pumping station 74, of which two are situated within the dispenser 54. By maintaining both the pump unit and the reservoir in the refrigerated section, any juice within the cavities of the disposable pump unit is maintained at its refrigerated temperature. The re-usable rigid container is preferably of a two part hinged construction for ease of use and may optionally have an angled lower surface (not shown) to aid the concentrate to drain, under the influence of gravity, towards the disposable pump unit 64. An angle of the surface of approximately 15 degrees was found to be most beneficial. The upper refrigerated cabinet area is cooled by means of a standard air blown refrigeration system as known in the art. The dispenser 54 has a drip tray 76 positioned below the point of dispense to retain any drips from the static mixers 68.

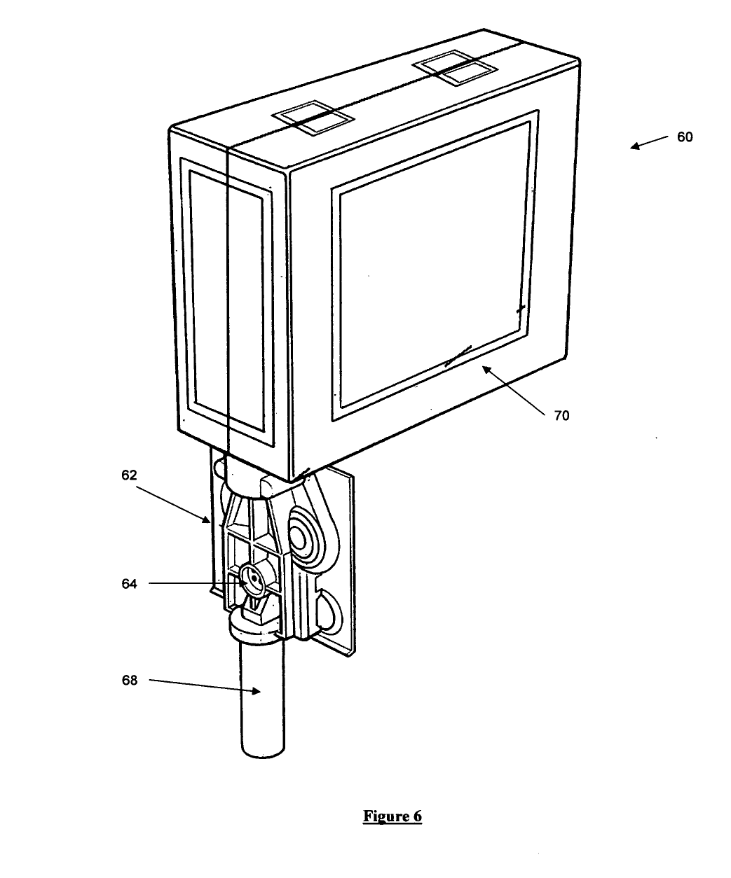

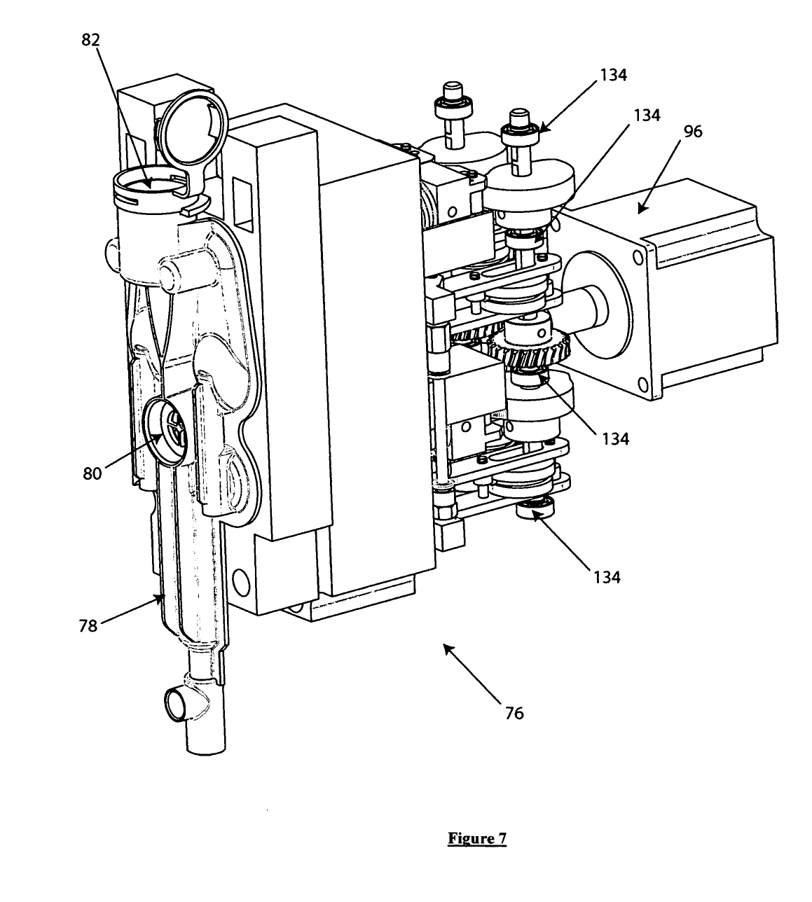

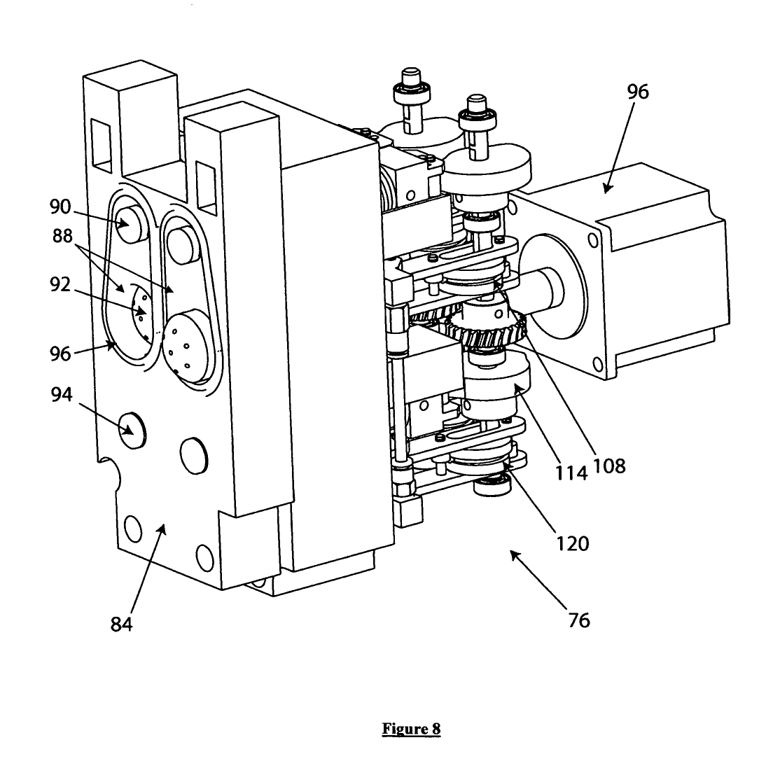

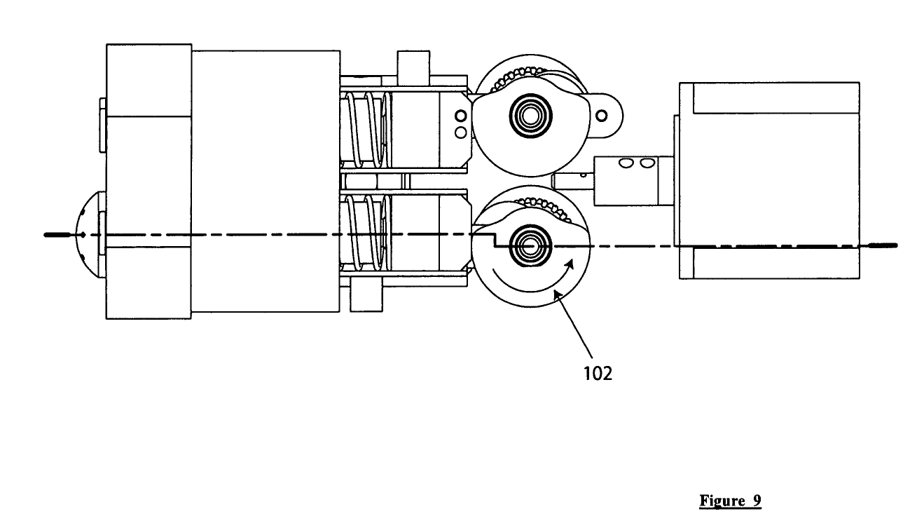

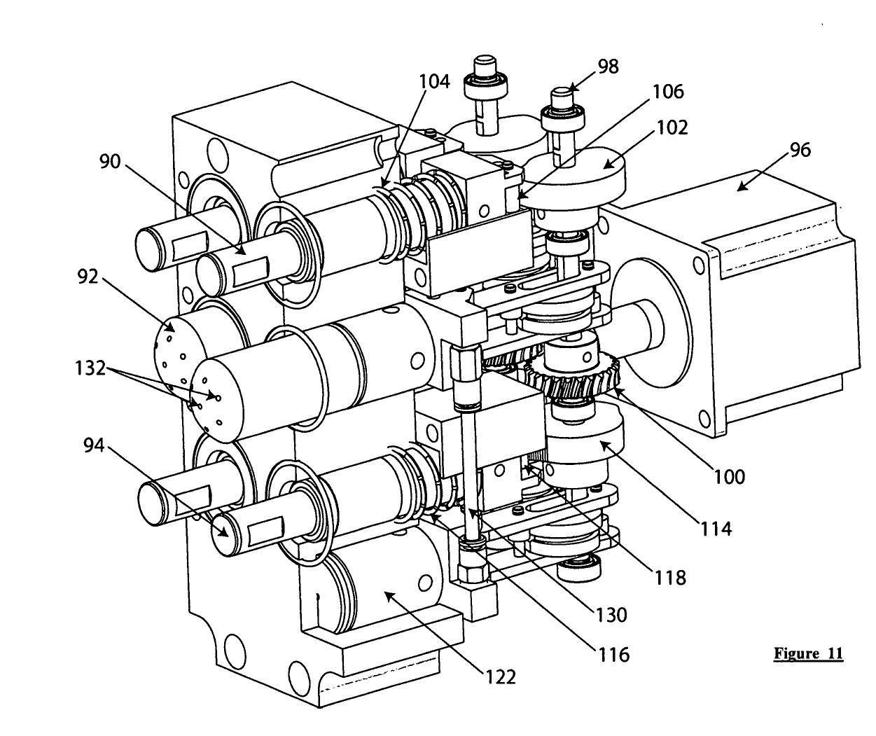

Referring to FIGS. 7 to 11, a pumping station 76 is shown for pumping juice from a pump cartridge as shown in FIG. 2. FIG. 7 shows the pumping station 76 with a cartridge 78 presented to it. In use, the cartridge 78 would be clamped into place against the pump station 76 and a diluent supply is supplied to the cartridge 78 at diluent inlet 80. In use, the concentrate inlet 82 is connected to a concentrate reservoir as shown in FIG. 6. FIG. 8 shows the same arrangement of pumping station 76 with the cartridge removed. The pumping station 76 has a face plate having a face 84 to which the cartridge is presented. The face has a seal 86 on it that seals between the cartridge 78 and the pumping station 76 around the periphery of the pump chamber of the cartridge. The face 84 has two recesses 88 therein, surrounded by the seal 86. In use, the flexible diaphragm covering the pump cavity of the cartridge 78 moves from a position in which it lies in the pump cavity when said pump cavity is empty to a position in which it extends out into the recess 88 in the face 84 when the pump cavity is full of concentrate. Extendable into each recess 88 is an inlet valve plunger 90 and a drive plunger 92. In use, the valve plunger 90 moves into the recess to press the flexible film onto the rim of the inlet orifice (30 FIG. 2), thereby closing it, and out of the recess to allow the film to move off the inlet orifice, thereby allowing it to open. The drive face 84 further has two outlet valve plungers 94 extendable therefrom. The outlet valve plungers operate in the same way as the inlet valve plungers to move the film on and off the outlet orifices (44 FIG. 2). The valve and drive plungers are driven by a mechanical drive linkage driven by a motor 96, as described below.

The mechanical drive linkage comprises two identical drive shafts 98 with associated components, each of which drives one set of inlet valve plunger, drive plunger and outlet valve plunger. The two drive shafts 98 are simultaneously driven through a bevel gear system 100 by a single motor 96. Each drive shaft has mounted to it four cams, each of which drives a different element of the pumping station. The uppermost cam 102 of each drive shaft 98 drives the inlet valve plunger. It is a follower cam and the outlet plunger 90 is maintained in contact with it by means of spring 104. The cam 102 acts against a roller 106 and moves the inlet valve plunger 90 into and out of the recess 88. The cam profile is such that it is in its withdrawn state (when the valve is open) for a shorter time than it is in its extended state (when the valve is shut). This enables the pump chambers to fill with concentrate in a shorter time than they empty the concentrate, enabling an overlap of concentrate output from each pump chamber to be achieved resulting in a substantially constant output form the cartridge 78. The second cam 108 is also a follower cam and moves the drive plunger 92 into and out of the recess 88. The drive plunger 92 has two follower rollers 110, 112 opposed to one another across the cam in the direction of plunger travel, thus the drive plunger 92 is driven in both directions by the cam. The third cam 114 drives the outlet valve plungers 94 and acts with spring 116 and roller 118 in the same way as the inlet valve cam and substantially 180 degrees out of phase with it. The cam 114 profile, however, is different and is profiled such that the valve open time is longer that the valve closed time. The forth cam 120 drives a small vacuum pump comprising vacuum plunger 122 and vacuum cavity (the cavity can not be seen in the drawings as the vacuum plunger 122 is in its fully extended position completely filling the vacuum cavity). The cam 120 has the same profile and acts in the same manner, with two rollers 124, 126, and in phase with the drive plunger 92 to reciprocate the vacuum plunger 122 in and out of the vacuum chamber. A vacuum conduit 128 passes through the vacuum plunger 122, through a connecting conduit 130, and then through the drive plunger wherein it splits and opens through ports 132 at the driving face thereof. The drive shafts are each held in captive by four bearings 134 in which they rotate.

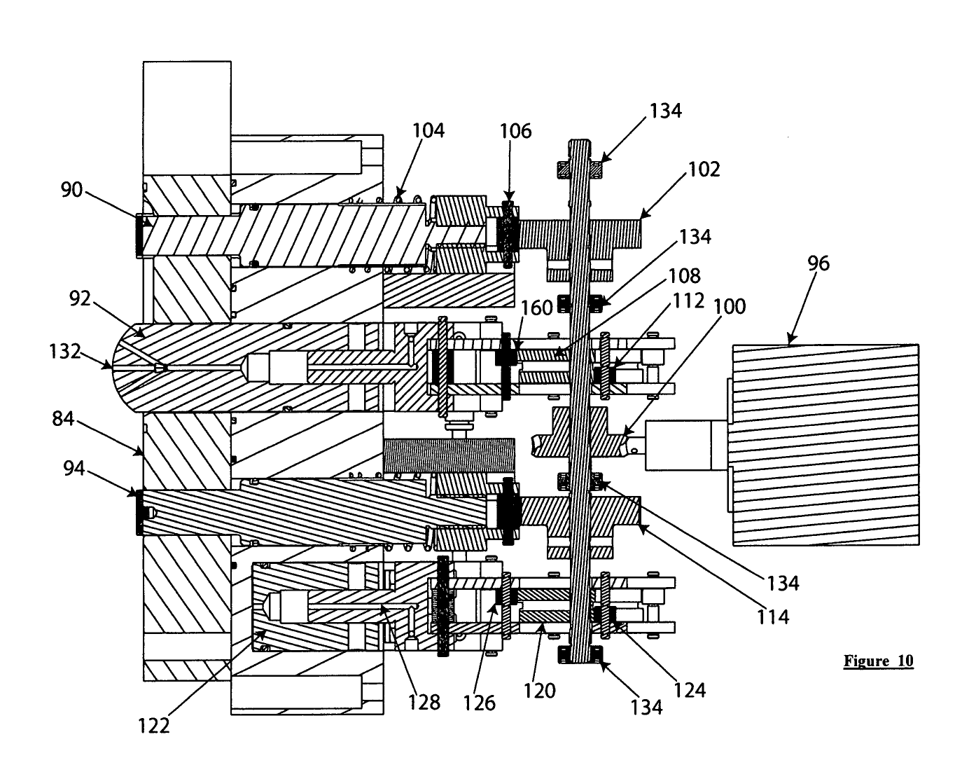

In use, starting from the position shown in the drawings and in relation to the valve-pump-valve arrangement in the FIG. 10, in its initial position both valves are closed and the drive plunger 92 is in its position extended into the recess 88, so the pump cavity is substantially empty. As the drive shaft 98 rotates in an anticlockwise direction, the inlet plunger 90 is withdrawn from the recess 99, thereby opening the inlet valve. Simultaneously or very shortly thereafter, the cams 108 and 120 act on the drive plunger 92 and the vacuum plunger 122 respectively, withdrawing them in unison. As the vacuum plunger is withdrawn, a vacuum is created in the vacuum chamber. This vacuum is conveyed by means of conduits 128 and 130 through the ports 132 to create a vacuum adjacent the flexible film of the pump cartridge 78. This vacuum draws the film towards the drive plunger 92 as it is withdrawn, causing concentrate to be drawn through the inlet orifice (30 FIG. 2) of the pump cartridge 78 and to fill the pump chamber. When the drive plunger 92 is fully withdrawn, the continuing rotation cams 102 and 114 attached to the drive shaft 98 causes the inlet valve to close and the outlet valve to open. As the outlet valve opens, or shortly thereafter, cams 108 and 120, by their continuing rotation, reverse the direction of the drive plunger 92 and the vacuum plunger 122. As the drive plunger 92 moves forwards, it expels concentrate from the pump cavity through the outlet orifice (44 FIG. 2), whereafter it mixes with a diluent entering the cartridge 78 via diluent inlet 80. The diluent and concentrate then pass through a static mixer, which is integral with the cartridge 78, and exit therefrom for consumption. Check valves, not shown, vent any air within the vacuum chamber out to atmosphere, thereby allowing, in operation, a permanent pressure differential to be effected across the flexible film of the pump cartridge 78. By maintaining this pressure differential, the position of the film can be maintained constant as the drive plunger 92 is reciprocated, thereby maintaining a dispense which is predictably related to the displacement of the drive plunger 92. This enables the mechanism to be stopped in any position and the ratiometric mix of a dispensed beverage will remain constant.

The two drive shafts 98 and associated components operate so as to drive the two sets of valve-pump-valve plungers substantially out of phase with one another. However, as the inlet valve is open for less than half of the cycle and the outlet valve is open for more than half of the cycle, there will be an overlap in the output of concentrate from the two pump chambers of the valve. This will give a substantially constant output of concentrate resulting in a ratiometric mixture of the dispensed beverage that is substantially constant independent of where in the cycle the dispense apparatus is stopped.

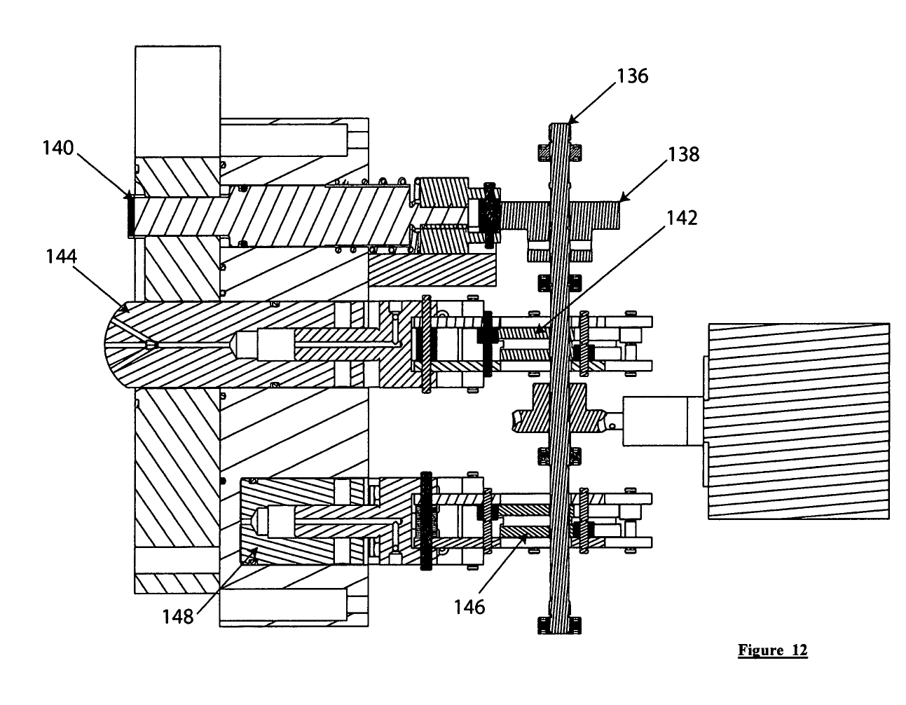

Referring to FIG. 12, a cross section of a pumping station is shown for use with the pump cartridge shown in FIG. 3. Essentially, this is identical to the pumping station shown in FIGS. 7 to 11, except in so much that as the pump cartridge of FIG. 3 has internal check valves on the outlet, the outlet valve plungers are not needed as the outlet valves no longer need external actuation. In this embodiment, there are only three cams on the drive shaft 136, a top cam 138 to drive the inlet valve plunger 140, a middle cam 142 to drive the drive plunger 144 and an lower cam 146 to drive the vacuum plunger 148. In all other respects the pumping station functions and pumps in the same way as described above.

Modifications of the invention, for example the replacement of the cam driven vacuum pump with a separate vacuum pump or combinations with any of the many known features of beverage dispensers, will be obvious to those skilled in the art and are within the scope of the invention.

What is claimed is:

1. A beverage dispenser for dispensing a post-mix beverage from a disposable concentrate pump unit comprising two inlet valves, two pump chambers having a flexible membrane and two outlet valves, the dispenser comprising:
a diluent supply system to supply a flow of diluent to a section of the disposable pump unit;
a cabinet area for receiving at least one reservoir of concentrate; and
at least one pumping station for receiving, retaining and actuating a disposable pump unit, wherein said pumping station comprises:
a drive plunger associated with each pump chamber and arranged for reciprocal movement to displace the flexible membrane in a first direction to expel concentrate from the pump chambers and in a second direction to draw concentrate into the pump chambers; and
vacuum means for applying a pressure differential across the flexible membrane when a drive plunger is moving in its second direction so as to cause concentrate to be drawn into the pump cavity as a drive plunger is withdrawn.

2. A beverage dispenser according to claim 1, wherein each drive plunger is driven by a cam.

3. A beverage dispenser according to claim 2, wherein the cams are profiled such that the movement of a drive plunger in the second direction is faster than movement of the plunger in the first direction resulting in concentrate being drawn into the pump chamber in a shorter time interval than it is expelled therefrom.

4. A beverage dispenser according to claim 1, wherein each pump chamber has a dedicated vacuum means and a conduit leading from said dedicated vacuum means to an outer side of the flexible membrane, the disposable concentrate pump sealingly engaging with the pumping station so as to form an enclosed area between each pump chamber and the pumping station.

5. A beverage dispenser according to claim 4, wherein each vacuum means comprises:
an enclosed chamber having an inlet check valve and an outlet check valve, the inlet check valve being in the conduit between the vacuum means and the outer side of the flexible membrane; and
a vacuum drive member movable in said enclosed chamber in a first direction to draw air through the inlet check valve and in the other direction to expel air from the enclosed chamber via the outlet check valve, thereby creating a pressure differential across the flexible membrane.

6. A beverage dispenser according to claim 4, wherein each conduit passes into and through a plunger and terminates at an opening in the end of the plunger which, in use, displaces the flexible membrane.

7. A beverage dispenser according to claim 5, wherein each vacuum drive member is driven by a cam.

8. A beverage dispenser according to claim 7, wherein each vacuum drive member cam and drive plunger cam, for each pump chamber, are driven by an associated common drive shaft.

9. A beverage dispenser according to claim 8, wherein the drive shafts for the pump chambers are driven simultaneously by a single motor.

10. A beverage dispenser according claim 1, wherein each of the concentrate pump inlet valves comprises a flexible membrane overlaying an inlet orifice and the pumping station further comprises an inlet valve plunger associated with each inlet orifice and arranged for reciprocal movement to displace the flexible membrane in a first direction to cover and close the inlet orifice thereby preventing flow of concentrate therethrough, and in a second direction to allow the membrane to move away from the orifice and allow concentrate to pass therethrough.

11. A beverage dispenser according to claim 10, wherein each inlet valve plunger is driven by the common drive shaft by means of a cam.

12. A beverage dispenser according to claim 1, wherein each of the concentrate pump outlet valves comprises a flexible membrane overlaying an outlet orifice and the pumping station further comprises an outlet valve plunger associated with each outlet orifice and arranged for reciprocal movement to displace the flexible membrane in a first direction to cover and close the outlet orifice thereby preventing flow of concentrate therethrough, and in a second direction to allow the membrane to move away from the orifice and allow concentrate to pass therethrough.

13. A beverage dispenser according to claim 12, wherein each outlet valve plunger is driven by the common drive shaft by means of a cam.

14. A beverage dispenser according to claim 11, wherein each cam is profiled to open the valve quickly, to maintain the valve in its open position as the pump chamber fills, and to then close the valve quickly.

15. A beverage dispenser according to claim 13, wherein each cam is profiled to open the valve quickly, to maintain the valve in its open position as the pump chamber fills, and to then close the valve quickly.

16. A beverage dispenser according to claim 1, wherein each outlet valve is a check valve.

17. A beverage dispenser according to claim 1, wherein the pumping station actuates the sets of inlet valves, pump chambers and outlet valves out of phase with each other.

18. A beverage dispenser according to claim 3, wherein the flows of concentrate expelled from the pump chambers overlap one another so that, in operation of the pump unit, concentrate is continuously expelled from the pump.

19. A beverage dispenser according to claim 1, wherein the diluent supply system comprises a flow meter to measure the flow of diluent passing therethrough.

20. A beverage dispenser according to claim 19, wherein the rate of pumping of concentrate is controlled dependant on the flow of diluent being supplied to the pump.

21. A beverage dispenser according to claim 20, including motor means for operating the pump unit, the flow rate of concentrate delivered by the pump unit being dependent upon the speed of the motor, and including means for controlling the speed of the motor dependant on the measured flow of diluent.

22. A beverage dispenser according to claim 21, wherein the flow of diluent is set to a desired flow rate.

23. A beverage dispenser according to claims 1, including a disposable pump cartridge comprising a concentrate inlet leading to the inlet valves, each inlet valve controlling the flow of concentrate to an associated one of the pump chambers having the flexible membrane, a diluent inlet, and the outlet valves.

24. A beverage dispenser according to claim 22, wherein the outlet valves comprise check valves allowing concentrate to flow in the direction out of the pump chambers.

25. A beverage dispenser according to claim 22, wherein the pump cartridge comprises a static mixer downstream from the pump chamber outlet valves and the diluent inlet.

26. A beverage dispenser according to claim 25 wherein, the static mixer comprises means to maintain a back pressure on the pump chambers and diluent inlet.

27. A beverage dispenser according to claim 26, wherein the means to maintain back pressure comprises a flow restriction at a downstream end of the static mixer.

28. A beverage dispenser according to claim 23, wherein the diluent inlet comprises a check valve to allow diluent to flow into the cartridge but preventing flow in the opposite direction.
